(19) United States
(12) Patent Application Publication
(10) Pub. No.: US 2021/0335330 A1
(43) Pub. Date: Oct. 28, 2021

(54) STRING INSTRUMENT COVER

(71) Applicant: Lee Allan Roy, Capistrano Beach, CA (US)

(72) Inventor: Lee Allan Roy, Capistrano Beach, CA (US)

(21) Appl. No.: 17/317,868

(22) Filed: May 11, 2021

Related U.S. Application Data
(63) Continuation of application No. 16/894,752, filed on Jun. 5, 2020.
(60) Provisional application No. 62/858,879, filed on Jun. 7, 2019.

(51) Int. Cl. G10G 7/00

(52) U.S. Cl. CPC G10G 7/00

(57) ABSTRACT

Provided herein are embodiments of a cover for musical instruments. The cover for musical instruments may cover the top of a guitar with a hood at the headstock. It may also cover the neck and body of the guitar using an attachment mechanism, e.g., a Velcro strap.

### CROSS-REFERENCE To RELATED APPLICATIONS

This application is a continuation of U.S. patent application Ser. No. 16/894,752, filed Jun. 5, 2020, which claims priority to U.S. Provisional Application No. 62/858,879, filed Jun. 7, 2019, the disclosures of which are hereby incorporated by reference in their entireties.

### FIELD

Embodiments of the present invention relate to cover for musical instruments, and more specifically to a cover for string instruments.

### BACKGROUND

Many owners of musical instruments need a cover to protect their instruments such as guitars from the elements. For example, in Southern California, the instruments need protection from elements such as dust from the wild fires, moisture from the ocean, UV rays from the sun just to name a few. One solution was to throw a blanket over the guitar, but it looks terrible and unprofessional. Existing products are cloth bags that look like having a blanket draping over the guitar.

In addition, many guitar enthusiasts do not like those products because they hide the guitars shape and allure. Also, the front and back of these covers or bags are sewn together so the owner would have to take the guitar off the stand to remove or insert the guitar into the bag.

Accordingly, there is a need for an improved cover for musical instruments, and more specifically to a cover for string instruments.

### SUMMARY

Provided herein are embodiments of a cover for musical instruments. The cover for musical instruments may cover the top of a guitar with a hood at the headstock. It may also cover the neck and body of the guitar using an attachment mechanism, e.g., a Velcro strap.

In some embodiments, the present disclosure may include a cover for musical instrument comprising: a hood portion; a neck portion connected to the hood portion; a body portion connected to the neck portion; and wherein the hood portion covers a head of the musical instrument, the neck portion comprises two flaps attachable using an attachment mechanism.

Other features and advantages of the present invention are or will become apparent to one skilled in the art upon examination of the following figures and detailed description, which illustrate, by way of examples, the principles of the present invention.

The systems, methods, and apparatuses described herein in detail for cover for musical instruments are example embodiments and should not be considered limiting. Other configurations, methods, features and advantages of the subject matter described herein will be or will become apparent to one with skill in the art upon examination of the following figures and detailed description. It is intended that all such additional configurations, methods, features and advantages be included within this description, be within the scope of the subject matter described herein and be protected by the accompanying claims. In no way should the features of the example embodiments be construed as limiting the appended claims, absent express recitation of those features in the claims.

### BRIEF DESCRIPTION OF THE DRAWINGS

The present invention may be better understood by referring to the following figures. The components in the figures are not necessarily to scale, emphasis instead being placed upon illustrating the principles of the disclosure. In the figures, reference numerals designate corresponding parts throughout the different views.

FIG. 1 illustrates a front view of a cover for musical instruments, according to exemplary embodiments of the present invention.

FIG. 2 illustrates a rear view of a cover for musical instruments, according to exemplary embodiments of the present invention.

FIG. 3 illustrates another rear view of a cover for musical instruments, according to exemplary embodiments of the present invention.

FIG. 4A illustrates a side view of a hood of a cover for musical instruments, according to exemplary embodiments of the present invention.

FIG. 4B illustrates a perspective view of a hood of a cover for musical instruments, according to exemplary embodiments of the present invention.

FIG. 5 illustrates a closeup rear view of a cover for musical instruments, according to exemplary embodiments of the present invention.

FIG. 6 illustrate a perspective view of another cover for musical instruments, according to exemplary embodiments of the present invention.

FIG. 7 illustrates a side view of another cover for musical instruments, according to exemplary embodiments of the present invention.

### DETAILED DESCRIPTION

The below described figures illustrate the described invention and method of use in at least one of its preferred, best mode embodiments, which is further defined in detail in the following description. Those having ordinary skill in the art may be able to make alterations and modifications to what is described herein without departing from its spirit and scope. While this invention is susceptible to different embodiments in different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated. All features, elements, components, functions, and steps described with respect to any embodiment provided herein are intended to be freely combinable and substitutable with those from any other embodiment unless otherwise stated. Therefore, what is illustrated is set forth only for the purposes of example and should not be taken as a limitation on the scope of the present invention.

In the following description and in the figures, like elements are identified with like reference numerals. The use of “e.g.,” “etc.,” and “or” indicates non-exclusive alternatives without limitation, unless otherwise noted. The use of “including” or “includes” means “including, but not limited to,” or “includes, but not limited to,” unless otherwise noted.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

Generally, the cover may cover the top of the guitar with a hood at the headstock. It may also cover the neck and body of the guitar using an attachment mechanism, e.g., a Velcro.

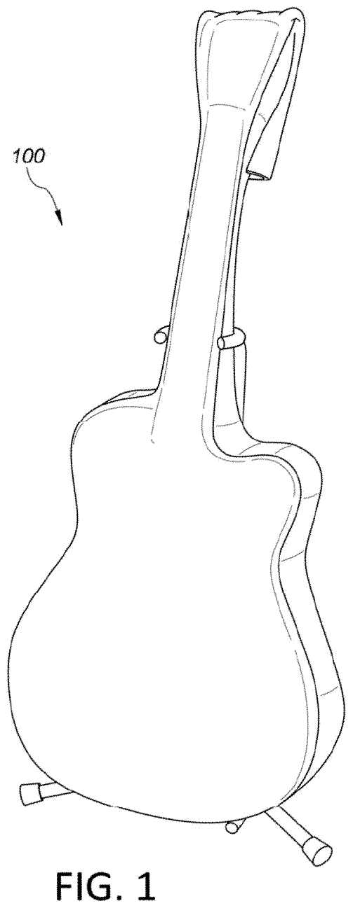

FIG. 1 illustrates a front view of a cover 100 for musical instruments, according to exemplary embodiments of the present invention.

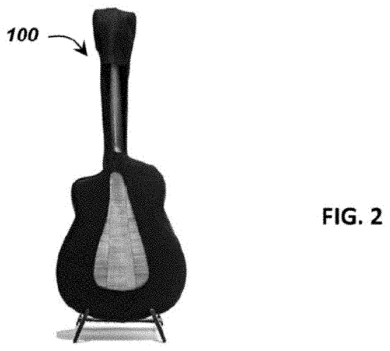

FIG. 2 illustrates a rear view of the cover 100 for musical instruments, according to exemplary embodiments of the present invention.

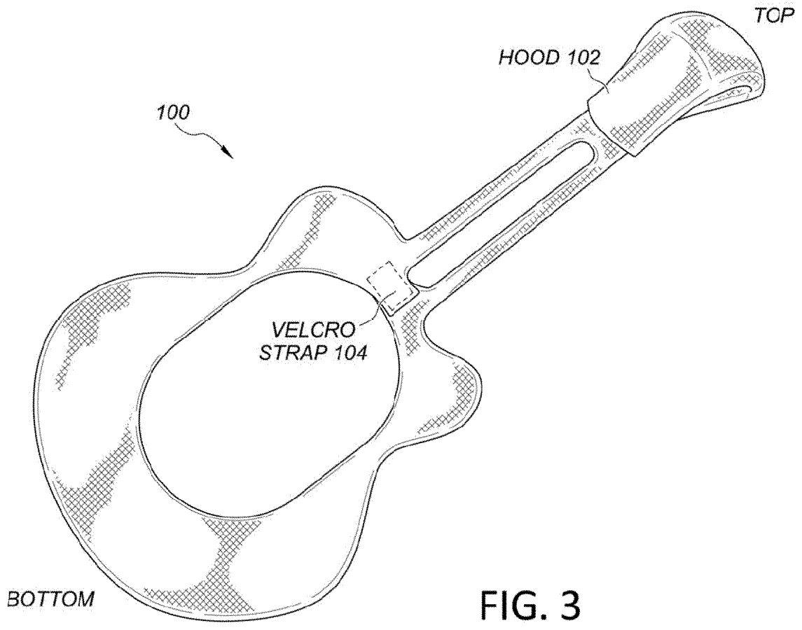

FIG. 3 illustrates another rear view of the cover 100 for musical instruments, according to exemplary embodiments of the present invention. In some embodiments, the cover 100 may include a hood 102 for covering the head, or headstock of the guitar. The bottom of the hood is open to allow the headstock entry. The cover 100 may wrap around the neck of the guitar with two flaps. The flaps may be open in the back of the cover, so the cover may slide onto the neck without obstruction. There may be an attachment mechanism 104, e.g., Velcro strap, attached to the side flaps to wrap around and close the flaps around the neck near the base of the neck. The body of the guitar, where the sound hole and electronics are located, may be covered on the top, bottom, and sides. Benefits of this cover may include the following examples, just to name a few:

The cover keeps the elements like dust, moisture, and sunlight from ruining the finish on acoustic electric and bass guitars. The cover also protects the strings, thereby allowing the strings to last longer.

The cover can be tailor fit for each guitar or other string instrument.

The cover has an open back so they can be easily removed and put back on while on a guitar stand.

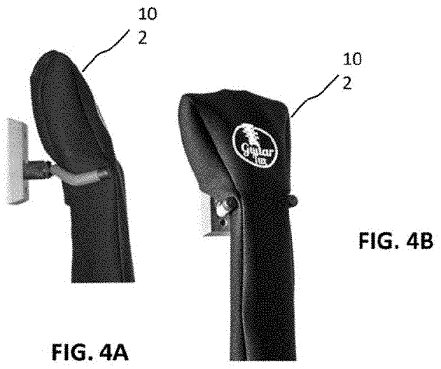

FIG. 4A illustrates a side view of the hood 102 of the cover 100 for musical instruments, according to exemplary embodiments of the present invention.

FIG. 4B illustrates a perspective view of a hood 102 of a cover 100 for musical instruments, according to exemplary embodiments of the present invention.

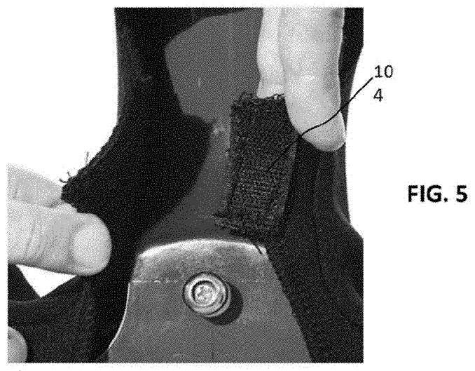

FIG. 5 illustrates a closeup rear view of the cover 100 for musical instruments near the bottom of the neck of the instrument, according to exemplary embodiments of the present invention. FIG. 5 shows the attachment mechanism 104 as a two-inch Velcro strap to attach the two side flaps.

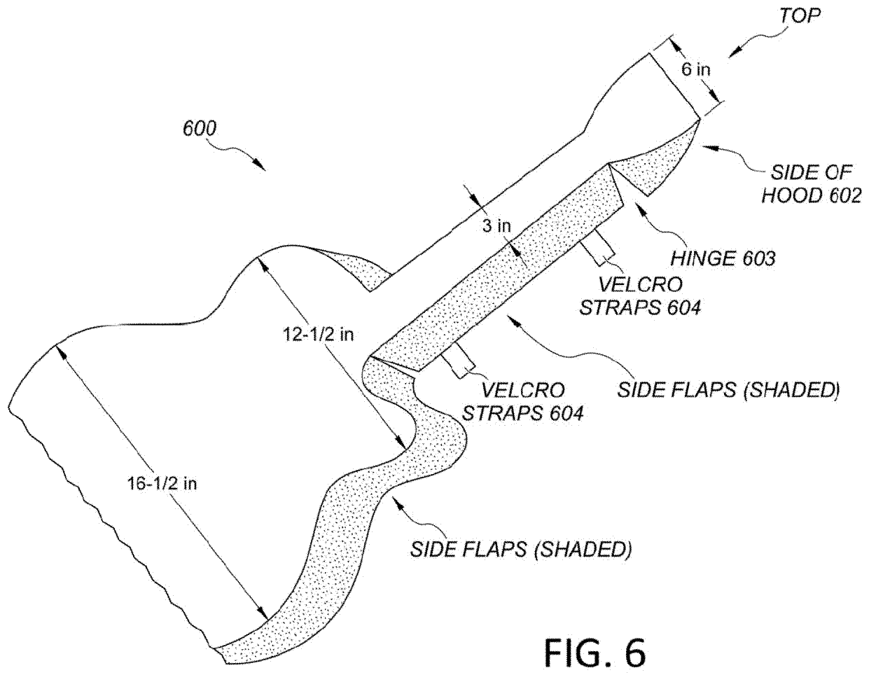

FIG. 6 illustrate a perspective view of another cover for musical instruments, according to exemplary embodiments of the present invention. The cover 600 may be similar to (and include all the same benefits) the cover 100, but using multiple attachments 604 (e.g., Velcro straps) for the neck of the instrument. In some embodiments, the cover 600 may include an optional hinge 603, for example, to open the hood 602.

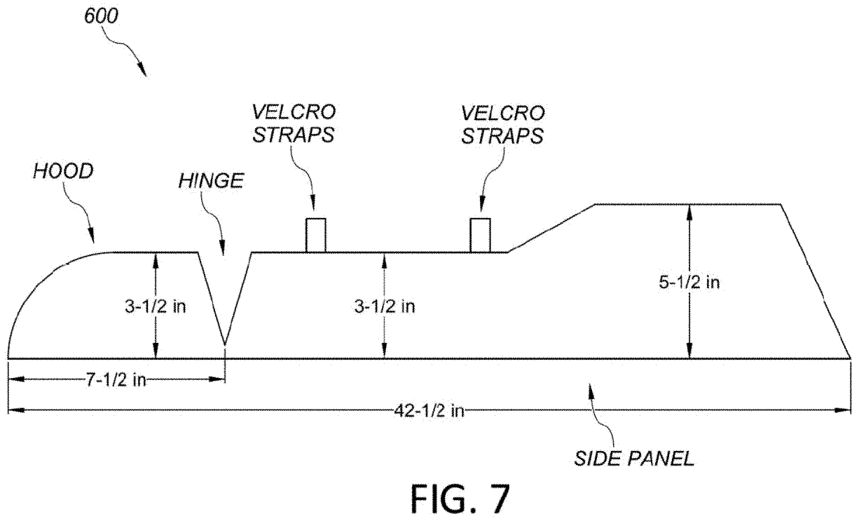

FIG. 7 illustrates a side view of the cover 600 for musical instruments, according to exemplary embodiments of the present invention.

The cover of the present disclosure may be made of stretchable fabric, cloth, neoprene, or any other suitable material.

It should be noted that although the examples above show a guitar, the cover of the present disclosure may be used for other instruments.

1. A cover for musical instrument comprising:
a hood portion;
a neck portion connected to the hood portion;
a body portion connected to the neck portion; and
wherein the hood portion covers a head of the musical instrument, the neck portion comprises two flaps attachable using an attachment mechanism.

2. The cover for musical instrument of claim 1, wherein the cover covers an entire front of the musical instrument.

3. The cover for musical instrument of claim 1, wherein the cover partially covers a rear of a neck of the musical instrument.

4. The cover for musical instrument of claim 1, wherein the cover partially covers a rear of a body of the musical instrument.

5. The cover for musical instrument of claim 1, wherein the attachment mechanism is located near a bottom of the neck portion.

6. The cover for musical instrument of claim 1, wherein the cover is made of a stretchable material.
